(19) United States
(12) Patent Application Publication
(10) Pub. No.: US 2026/0074573 A1
(43) Pub. Date: Mar. 12, 2026

(54) GENERATING ELECTROMAGNETIC FORCES THROUGH RADIAL AIR GAPS

(71) Applicant: Calnetix Technologies, LLC, Cerritos, CA (US)

(72) Inventor: Alexei Filatov, Irvine, CA (US)

(21) Appl. No.: 18/883,878

(22) Filed: Sep. 12, 2024

(51) Int. Cl. H02K 1/14; H02K 1/17; H02K 7/14; H02K 11/21

(52) U.S. Cl. CPC H02K 1/14; H02K 1/17; H02K 7/14; H02K 11/21

(57) ABSTRACT

An electromagnetic actuator supports a body, and has an axial actuator target affixed to the body and a stationary axial control pole assembly. The pole assembly has first and second axial control poles both residing entirely radially outward from the body and both separated from the axial actuator target by radial air gaps. The axial control poles reside adjacent end-facing surfaces of the axial actuator target to communicate magnetic flux with the end-facing surfaces. The axial control poles are magnetically coupled with the axial actuator target to define an axial magnetic control circuit. The actuator has an axial control coil configured to induce an axial control magnetic flux in the axial magnetic control circuit when energized. A permanent magnet is affixed to the body to induce a bias magnetic flux between the axial actuator target and the axial control pole assembly.

### TECHNICAL FIELD

This disclosure relates to generating electromagnetic forces, and, more particularly, to generating axial and radial electromagnetic forces through radial air gaps.

### BACKGROUND

Equipment and machinery often contain moving (e.g., rotating, translating) members, which require support during operation. A bearing, or similar device, may be used to support the moving member. Although some bearings may require direct contact with the member to provide the necessary support, some applications benefit from non-contact, or nearly non-contact, support for the member.

### SUMMARY

An electromagnetic actuator may be used to apply electromagnetic forces in axial and radial directions on a body configured to rotate about a rotational axis in a non-contact, or nearly non-contact, manner. In some implementations, the electromagnetic actuator may be used to support the body without mechanical contact.

The electromagnetic actuator may include a plurality of actuator targets spaced axially along the rotational axis and affixed to the body. The actuator targets may be axial actuator targets or radial actuator targets. The electromagnetic actuator may include a plurality of rotating permanent magnets affixed to the body and placed between the actuator targets. The magnet magnetization directions may alternate from magnet to magnet along the rotational axis. Each pole of a rotating magnet may be magnetically coupled to the neighboring actuator target. Each axial actuator target may have a first end-facing surface and a second end-facing surface. Each radial actuator target may have an exterior lateral surface.

The electromagnetic actuator may have a plurality of stationary control pole assemblies, one control pole assembly for each of the actuator targets. The control pole assemblies may be axial control pole assemblies or radial control pole assemblies. Axial control pole assemblies may be associated with axial actuator targets, radial control pole assemblies may be associated with radial actuator targets.

Each axial control pole assembly may include of a first axial control pole and a second axial control pole. The first axial control pole may be adjacent the first end-facing surface of the associated axial actuator target, separated from it by a radial air gap, offset axially away from the associated axial actuator target and adapted to communicate magnetic flux across the radial gap with the first end-facing surface of the axial actuator target. The second stationary axial control pole may be adjacent the second end-facing surface of the associated axial actuator target, separated from it by a radial air gap, offset axially away from the associated axial actuator target and adapted to communicate magnetic flux across a gap with the second end-facing surface of the associated axial actuator target. The first stationary axial control poles and the second stationary axial control poles associated with the same axial actuator targets may be magnetically coupled and cooperate with the associated axial actuator targets to define an axial control magnetic circuit. Axial control coils may be used to induce axial control magnetic fluxes in the axial control magnetic circuits. The directions of the axial control magnetic fluxes may alternate along the rotational axis.

Each radial control pole assembly may include at least three radial control poles distributed around the body in an axial plane perpendicular to the body axis, adjacent and spaced apart from an exterior lateral surface of the associated radial actuator target. The radial control poles in each radial control pole assembly may be configured to communicate magnetic flux with the associated radial actuator target, magnetically coupled to each other and define radial control magnetic circuits. Excitation coils wound around the radial control poles may be configured to produce control magnetic fluxes in the radial control magnetic circuits when energized with electrical radial control currents.

The electromagnetic actuator may include a plurality of stationary permanent magnets placed between two neighboring control pole assemblies, either axial or radial. Each said stationary permanent magnet may have its magnetization direction opposite to the magnetization direction of the associated rotating magnet placed between two actuator targets associated with the neighboring control pole assemblies and may have its poles magnetically coupled to the neighboring control pole assemblies. The stationary permanent magnets, the neighboring control pole assemblies, the associated actuator targets and the associated rotating magnets may define bias magnetic circuits with the stationary permanent magnets and rotating permanent magnets inducing bias magnetic fluxes in the bias magnetic circuits.

In certain instances of the embodiments, the magnetic flux entering the first and second end-facing surfaces of the axial actuator target may exert an axial force on the body. Similarly, the magnetic fluxes entering the exterior lateral surface of the radial actuator target may exert radial forces on the body. These axial and radial forces are proportional to the magnetic control fluxes in the axial and radial magnetic control circuits respectively.

In some embodiments non-magnetic compressive sleeves may be shrunk on top of the rotating magnets to keep the magnet material in compression when rotating to prevent magnet disintegration under the centrifugal forces.

In some embodiments, a non-magnetic sleeve may be installed over the actuator targets to protect them from aggressive environments such as those including corrosive sour gases (H2S).

In some embodiments, a method for exerting an axial electromagnetic force on a body having a rotational axis may include the following steps. A bias magnetic flux may be generated by a stationary permanent magnet and a rotating magnet attached to the body. The bias magnetic flux may be introduced into an axial actuator target. A first portion of the bias magnetic flux may be directed between a first end-facing surface of the axial actuator target and a first axial control pole separated from the first end-facing surface of the axial actuator target by a radial air gap and axially offset away from it. A second portion of the bias magnetic flux may be directed between a second end-facing surface of the axial target and a second axial control pole separated from the second end-facing surface of the axial actuator target by a radial air gap and axially offset away from it. An axial control magnetic flux may be directed to flow through the first axial control pole, the first end-facing surface of the axial target, the second end-facing surface of the axial target, and the second axial control pole. In certain instances of the embodiments, the axial control magnetic flux may be generated by a current in a conductive axial control coil wound around the body axis.

In some embodiments, a method for exerting a radial electromagnetic force on a body having a rotational axis may include the following steps. A bias magnetic flux may be generated by a stationary permanent magnet and a rotating magnet attached to the body. The bias magnetic flux may be introduced into a radial actuator target and travel radially through a radial gap between the exterior lateral surface of the radial actuator target and at least three radial control poles distributed around the body in a single plane perpendicular to the body axis. Control magnetic flux may be introduced into the radial control pole, which may add to the bias magnetic flux under some poles and subtract from it under the other poles. In certain instances of the embodiments, the radial control magnetic fluxes may be generated by currents in conductive radial control coils wound around the radial control poles.

In some embodiments, an electric machine system may include the following components. The system may include a stator. A rotor may have a rotational axis configured to move relative to the stator. An electromagnetic actuator subassembly may be included. One or more position sensors may be configured to sense the position of the rotor. At least one control electronics package may be configured to control the magnetic fluxes in the axial magnetic control circuits and the radial magnetic control circuits.

The electromagnetic actuator subassembly may include an axial actuator target affixed to the rotor and having first and second end-facing surfaces. A first axial control pole may be residing apart from the rotor adjacent to the first end-facing surface of the axial actuator target, separated from it by a radial air gap, offset axially away from the axial actuator target and configured to communicate magnetic flux with it. A second axial control pole may be residing apart from the rotor adjacent to the second end-facing surface of the axial actuator target, separated from it by a radial air gap, offset axially away from the axial actuator target and configured to communicate magnetic flux with it. The first axial control pole and the second axial control pole may be magnetically coupled to each other. A stationary permanent magnet may be configured to generate magnetic bias fluxes flowing between the axial actuator target and the axial control poles. A rotating permanent magnet may be configured to generate magnetic bias fluxes flowing between the axial actuator target and the stationary axial control poles. A stationary permanent magnet and a rotating permanent magnet may be configured so that the bias magnetic fluxes they generate add to each other. The first axial control pole, the second axial control pole and the axial actuator target may form an axial magnetic control circuit; an axial control conductive coil may be adapted to produce an axial control magnetic flux in the axial control magnetic circuit. An axial force may be exerted on the axial actuator target when the axial control magnetic flux is superimposed on the bias flux.

The electromagnetic actuator subassembly may include a radial actuator target affixed to the rotor and having an exterior lateral surface. At least three radial control poles may be distributed around the body in a single plane perpendicular to the body axis, adjacent and spaced apart from an exterior lateral surface of the associated radial actuator target, the radial actuator target and the radial control poles defining a plurality of radial magnetic control circuits. A stationary permanent magnet may be configured to generate magnetic bias fluxes flowing between the radial actuator target and the stationary radial control poles. A rotating permanent magnet may be configured to generate magnetic bias fluxes flowing between the radial actuator target and the stationary radial control poles. A stationary permanent magnet and a rotating permanent magnet may be configured so that the bias magnetic fluxes they generate add to each other. Radial control conductive coils may be wound around the radial control poles and adapted to produce radial control magnetic fluxes in the radial control magnetic circuits. Radial forces may be exerted on the radial actuator target when the radial control magnetic fluxes are superimposed on the bias flux.

In certain instances of the embodiments, the rotor may be coupled to a driven load. The driven load may include at least one of a flywheel, a compressor, a generator, or an expander.

In certain instances of the embodiments, the rotor may be coupled to a driver. The driver may include at least one of a motor, an engine, or a turbine.

In certain instances of the embodiments, the electronic control package may be configured to control the magnetic fluxes in the axial and radial control magnetic circuits by energizing axial and radial control conductive coil with control currents. The magnetic fluxes may exert electromagnetic forces on the actuator target. The electronic control package may be further configured to energize the axial and radial control conductive coil with control currents in response to changes of signals from the position sensors so that the rotor may be supported by electromagnetic forces without a mechanical contact with the stator.

### DESCRIPTION OF DRAWINGS

FIG. 1 shows a radial cross-sectional schematic of an electromagnetic actuator in accordance with the present disclosure comprising two axial control pole assemblies to generate axial forces through radial air gaps and illustrates generating an axial electromagnetic force.

FIG. 2 shows a radial cross-sectional schematic of an electromagnetic actuator in accordance with the present disclosure comprising one axial and one radial control pole assemblies to generate axial and radial forces through radial air gaps and illustrates generating an axial electromagnetic force.

FIG. 3 shows an axial cross-sectional schematic of an electromagnetic actuator per FIG. 2 and illustrates generating a radial electromagnetic force.

FIG. 4 shows a radial cross-sectional schematic of an electromagnetic actuator in accordance with the present disclosure comprising three axial control pole assemblies to generate axial forces through radial air gaps.

FIG. 5 shows a radial cross-sectional schematic of an electromagnetic actuator in accordance with the present disclosure comprising two axial and one radial control pole assemblies to generate axial and radial forces through radial air gaps.

FIG. 6 shows a radial cross-sectional schematic of an electromagnetic actuator in accordance with the present disclosure comprising one axial and two radial control pole assemblies to generate axial and radial forces through radial air gaps.

FIG. 7 shows a radial cross-sectional schematic of an electromagnetic actuator per FIG. 6 with an addition of magnet sleeves and an overall protective sleeve.

FIG. 8 is a radial cross-sectional schematic of an electric machine system incorporating an embodiment of the electromagnetic actuator to generate axial and radial forces through radial air gaps in accordance with the present disclosure.

Like reference symbols in the various drawings indicate like elements.

### DETAILED DESCRIPTION

This disclosure relates to generating electromagnetic forces by using an electromagnetic actuator and, more particularly, to generating axial electromagnetic forces or both axial and radial electromagnetic forces through radial air gaps.

An Active Magnetic Bearing (AMB) uses an electromagnetic actuator to apply a controlled electromagnetic force to support a moving member in a non-contact, or nearly non-contact, manner. The non-contact or nearly non-contact support provided by the magnetic bearing can provide frictionless or nearly frictionless movement of the member in both the axial and radial directions. In certain implementations electromagnetic actuators may use permanent magnets and may be referred to as Permanent-Magnet-Biased Electromagnetic Actuators.

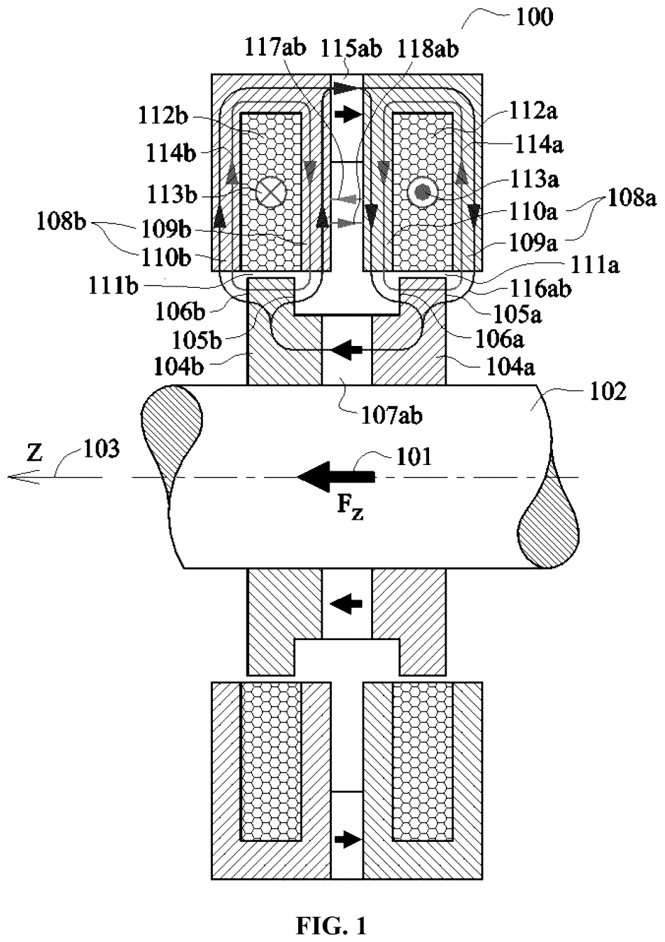

FIG. 1 shows a radial cross-section of an electromagnetic actuator 100 in accordance with the present disclosure and illustrates generating an axial force F_{z} 101 applied to a body 102 which may be able to rotate about axis Z 103. The electromagnetic actuator 100 may include a first axial actuator target 104a and a second axial actuator target 104b spaced along the rotational axis Z 103 with the second axial actuator target 104b having a higher Z coordinate than the first axial actuator target 104a. The first axial actuator target 104a and the second axial actuator target 104b may be affixed to the body 102. The first axial actuator target 104a may include a first end-facing surface 105a and a second end-facing surface 106a with the second end-facing surface 106a having a higher Z coordinate than the first end-facing surface 105a. Similarly, the second axial actuator target 104b may include a first end-facing surface 105b and a second end-facing surface 106b with the second end-facing surface 106b having a higher Z coordinate than the first end-facing surface 105b. The electromagnetic actuator 100 may include a rotating magnet 107ab affixed to the body 102 and having its opposite poles magnetically coupled to the axial actuator targets 104a and 104b.

The electromagnetic actuator 100 may include two stationary axial control pole assemblies 108a and 108b spaced axially along the rotational axis 103 with the axial control pole assembly 108b having a higher Z coordinate than the axial control pole assembly 108a. The pole assemblies 108a and 108b are “stationary” in the sense that they do not rotate with the body 102, but, of course, are movable with the machine having the electromagnetic actuator and body 102.

The axial control pole assembly 108a may include a first axial control pole 109a and a second axial control pole 110a. The first axial control pole 109a may be adjacent the first end-facing surface 105a of the axial actuator target 104a, separated from it by radial air gap 111a, offset axially away from the axial actuator target 104a and adapted to communicate magnetic flux with the first end-facing surface 105a. The second axial control pole 110a may be adjacent the second end-facing surface 106a of the axial actuator target 104a, separated from it by radial air gap 111a, offset axially away from the axial actuator target 104a and adapted to communicate magnetic flux with the second end-facing surface 106a. The first axial control pole 109a and the second axial control pole 110a may be magnetically coupled and, together with the axial actuator target 104a, define a first axial control magnetic circuit. An electrical coil 112a with a current 113a may be adapted to induce a first axial control magnetic flux 114a in the first axial control magnetic circuit.

The axial control pole assembly 108b may include a first axial control pole 109b and a second axial control pole 110b. The first axial control pole 109b may be adjacent the first end-facing surface 105b of the axial actuator target 104b, separated from it by radial air gap 111b, offset axially away from the axial actuator target 104b and adapted to communicate magnetic flux with the first end-facing surface 105b. The second axial control pole 110b may be adjacent the second end-facing surface 106b of the axial actuator target 104b, separated from it by radial air gap 111b, offset axially away from the axial actuator target 104b and adapted to communicate magnetic flux with the second end-facing surface 106b. The first axial control pole 109b and the second axial control pole 110b may be magnetically coupled and, together with the axial actuator target 104b, define a second axial control magnetic circuit. An electrical coil 112b with a current 113b may be adapted to induce a first axial control magnetic flux 114b in the first axial control magnetic circuit.

The first and the second axial control magnetic fluxes 114a and 114b may be directed identically if the axial control currents 113a and 113b are directed identically.

The electromagnetic actuator 100 may include a stationary permanent magnet 115ab, which may be placed between the axial control poles 110a and 109b and may have the magnetization direction opposite the magnetization direction of the permanent magnet 107ab. The permanent magnets 107ab and 115ab, the axial actuator target 104a and 104b, the axial control pole assemblies 108a and 108b may define a bias magnetic circuit with magnets 107ab and 115ab inducing a bias magnetic flux 116ab.

The axial control currents 113a and 113b may be directed oppositely to produce oppositely directed control magnetic fluxes 114a and 114b. Depending on the magnetization direction of the permanent magnets 107ab and 115ab as well as the directions of the axial control currents 113a and 113b, the axial control magnetic fluxes 114a and 114b may add to or subtract from the bias flux 116ab on the second end-facing surface 110a and 110b, whereas they would oppositely subtract from or add to the bias flux 116ab on the first end-facing surface 109a and 109b, resulting in a net axial force F_{z} 101 exerted on the axial actuator targets 104a and 104b and subsequently transmitted to the body 102.

The stationary permanent magnet 115ab may induce a leakage magnetic flux 117ab between the axial control poles 110a and 109b. To accommodate this leakage flux in addition to the bias flux 116ab and control fluxes 114a and 114b, the axial control poles 110a and 109b may need to be thickened, increasing overall length and weight of the actuator 100. The permanent magnet 107ab may also introduce a leakage magnetic flux 118ab between the axial control poles 110a and 109b, which would be directed opposite to the leakage flux 117ab, thereby subtracting from it and mitigating the need to increase the thicknesses of the axial control poles 110a and 109b.

To effectively conduct magnetic fluxes, the axial actuator targets 104a and 104b as well as the stationary axial control poles 109a, 110a, 109b, 110b may include or be composed of soft-magnetic materials such as carbon steels.

The axial control pole assemblies 108a and 108b are shown in FIG. 1 residing entirely radially outward from the axial actuator targets 104a and 104b, permanent magnet 107ab and the body 102. In certain instances, this configuration allows the body 102, targets 104a and 104b and permanent magnet 107ab to move freely along the rotational axis into/out of the axial control pole assemblies 108a and 108b without needing to disassemble either axial control pole assembly 108a and 108b. In certain instances, this configuration can provide design freedom in mechanically supporting the soft-magnetic material of the axial actuator targets 104a and 104b and supporting the permanent magnet 107ab, allowing the targets and permanent magnet to be flush with or partially or wholly recessed from the outer circumferential surface of the body 102 and/or the axial ends of the axial actuator target 104a and/or target 104b to be supported by material that does not need to participate in the magnetic circuit. This can allow the material adjacent to and axially supporting the targets to be selected based on other characteristics (e.g., strength, elastic modulus, corrosion resistance and/or other characteristics) rather than primarily its soft-magnetic properties.

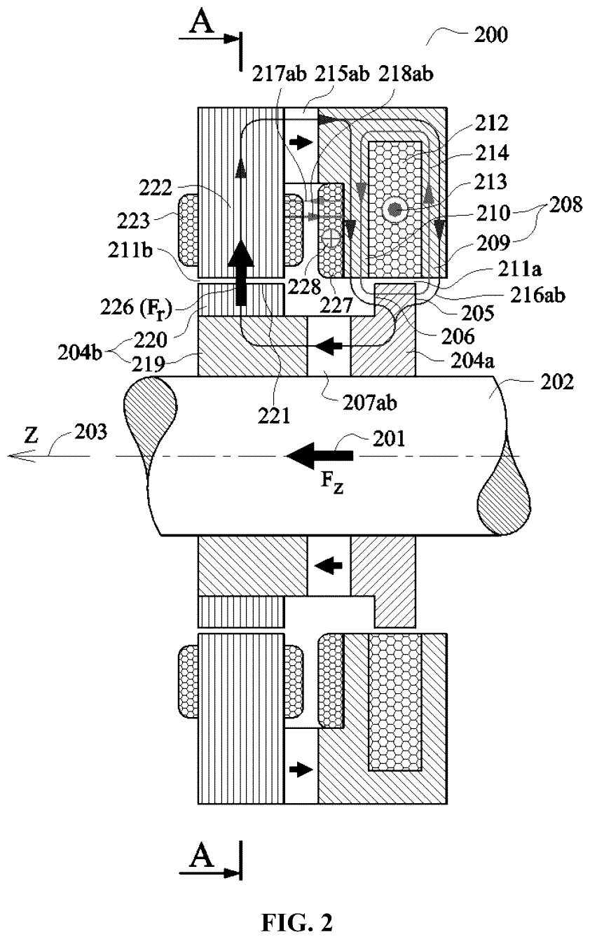

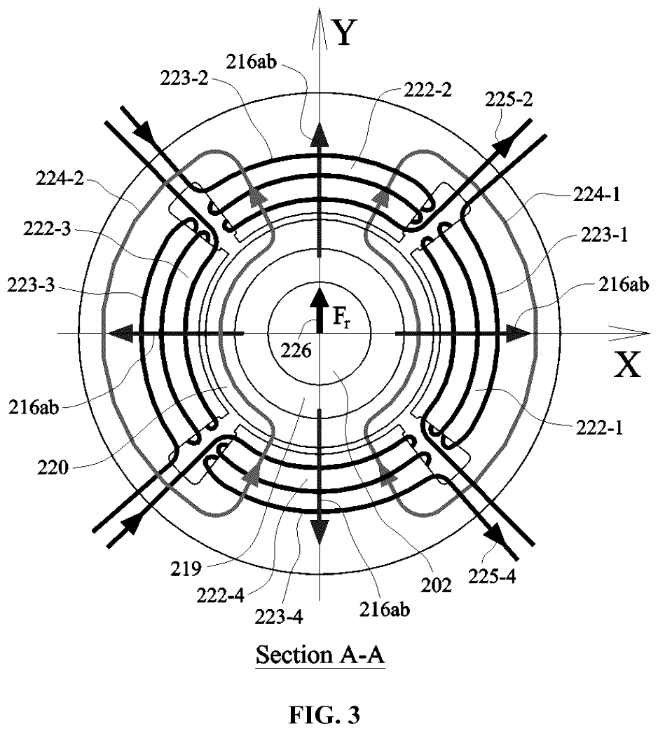

FIGS. 2 and 3 show another implementation of the electromagnetic actuator 200 capable of producing both axial and radial forces. FIG. 2 shows an axial cross-section of the electromagnetic actuator 200 and illustrates generating an axial force F_{z} 201 applied to a body 202 which may be able to rotate about axis Z 203. The electromagnetic actuator 200 may include an axial actuator target 204a and a radial actuator target 204b spaced along the rotational axis Z 203. The axial actuator target 204a and the radial actuator target 204b may be affixed to the body 202. The axial actuator target 204a may include a first end-facing surface 205 and a second end-facing surface 206. The radial actuator target 204b may include of a solid radial actuator portion 219 and a laminated radial actuator portion 220 placed on top of the solid radial actuator portion 219 and magnetically coupled to it. The laminated radial actuator portion 220 may be composed of insulated laminations made of electrical steel and stacked in the axial direction. The laminated radial actuator target portion 220 may have an exterior lateral surface 221. The electromagnetic actuator 200 may include a rotating magnet 207ab affixed to the body 202 and having its opposite poles magnetically coupled to the axial actuator target 204a and the radial actuator target 204b.

The electromagnetic actuator 200 may include stationary axial control pole assembly 208 which may include a first axial control pole 209 and a second axial control pole 210. The first axial control pole 209 may be adjacent the first end-facing surface 205 of the axial actuator target 204a, separated from it by radial air gap 211a, offset axially away from the axial actuator target 204a and adapted to communicate magnetic flux with the first end-facing surface 205. The second axial control pole 210 may be adjacent the second end-facing surface 206 of the axial actuator target 204a, separated from it by radial air gap 211a, offset axially away from the axial actuator target 204a and adapted to communicate magnetic flux with the second end-facing surface 206. The first axial control pole 209 and the second axial control pole 210 may be magnetically coupled and, together with the axial actuator target 204a, define an axial control magnetic circuit. An electrical coil 212 with a current 213 may be adapted to induce an axial control magnetic flux 214 in the axial control magnetic circuit.

The electromagnetic actuator 200 may include radial control pole assembly 222 which may be adjacent the exterior lateral surface 221 of the radial actuator target 204b, separated from it by radial air gap 211b and adapted to communicate magnetic flux with the exterior lateral surface 221. The stationary radial control pole assembly 222 may include of at least three radial control poles distributed around the body in a single plane perpendicular to the body axis, adjacent and spaced apart from an exterior lateral facing surface of the associated radial actuator target. FIG. 3 shows four poles 222-1 through 222-4 as an example. The radial control poles, such as 222-1 through 222-4 in FIG. 3, are magnetically coupled to each other and to the laminated portion 220 of the radial actuator target 204b to form a plurality of radial control magnetic circuits. Each radial control pole, such as 222-1 through 222-4 in FIG. 3, is equipped with a radial control winding, such as 223-1, 223-2, 223-3 and 223-4 in FIG. 3, which may induce radial control magnetic fluxes, such as 224-1 and 224-2 in FIG. 3, in the radial control magnetic circuits when energized with radial control electric currents such as 225-2 and 225-4 in FIG. 3.

The electromagnetic actuator 200 may include a stationary permanent magnet 215ab, which may be placed between the axial control pole 210, closest to the radial control pole assembly 222, and the radial control pole assembly 222. The axial control pole 210 and the radial control pole assembly 222 may be magnetically coupled to the opposite poles of the stationary permanent magnet 215ab. The stationary permanent magnet 215ab may have the magnetization direction opposite the magnetization direction of the rotating permanent magnet 207ab. The permanent magnet 215ab and 207ab, the axial actuator target 204a, the radial actuator target 204b, the axial control pole assembly 208 and the radial control pole assembly 222 define a bias magnetic circuit with magnets 215ab and 207ab inducing a bias magnetic flux 216ab.

Depending on the magnetization directions of the permanent magnets 207ab and 215ab as well as the direction of the axial control current 213, the axial control magnetic flux 214 may add to or subtract from the bias flux 216ab on the end-facing surfaces 206, whereas it would subtract from or add to the bias flux 216ab respectively on the end-facing surface 205 resulting in a net axial force F_{z} 201 exerted on the pole piece 204a and subsequently transmitted to the body 202.

Depending on the magnetization direction of the permanent magnets 207ab and 215ab as well as the directions of the radial control currents such as 225-1 and 225-4, the radial control magnetic fluxes these currents produce may add to or subtract from the bias fluxes 216ab in the radial control poles 222-1 through 222-4, which may cause radial forces Fᵣ 226 exerted on the radial actuator target 204b and subsequently transmitted to the body 202. For example, in FIG. 3 the radial control magnetic fluxes 224-1 and 224-2 add to the bias flux 216ab in the upper radial control pole 222-2 but subtract from the bias flux 216ab in the lower radial control pole 222-4, resulting in the radial force Fᵣ 226 directed upwards.

The stationary permanent magnet 215ab may induce a leakage magnetic flux 217ab between the axial control pole 210 and the radial control pole assembly 222. To accommodate this leakage flux in addition to the bias flux 216ab and control fluxes 224-1 and 224-2, the axial control pole 210 and the radial control pole assembly 222 may need to be thickened, increasing overall length and weight of the actuator 200. The permanent magnet 207ab may also introduce a leakage magnetic flux 218ab between the axial control pole 210 and the radial control pole assembly 222, which would be directed opposite to the leakage flux 217ab, thereby subtracting from it and mitigating the need to increase the thicknesses of the axial control pole 210 and the radial control pole assembly 222.

To prevent the axial control current 213 affecting the bias magnetic flux 216ab, a compensation coil 227 with a compensation current 228 opposite to the axial control current 214 may be added between the second axial control pole 210 and the radial control pole assembly 222 as described in the U.S. Pat. No. 8,482,174.

To effectively conduct magnetic fluxes, the axial actuator target 204a and a solid portion 219 of the radial actuator target 204b as well as the stationary axial control poles 209 and 210, may include or be composed of soft-magnetic materials such as carbon steels.

As above, the axial control pole assembly 208 is shown residing entirely radially outward from the axial actuator target 204a, permanent magnet 207ab and the body 202, as well as the radial actuator target 204b. Likewise, the radial control pole assembly 222 is entirely radially outward from the axial actuator target 204a, permanent magnet 207ab, radial actuator target 204b and body 202. In certain instances, this configuration enables the assembly convenience and/or design freedom discussed above.

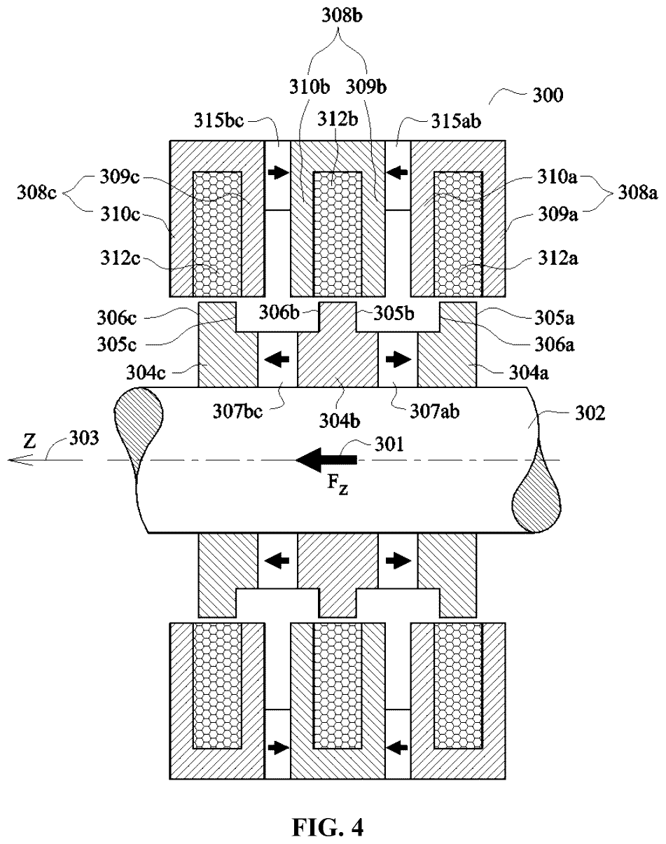

Any number of axial or radial actuator targets along with associated axial or radial control pole assemblies may be stacked along the body axis to achieve necessary load capacities without increasing the rotor assembly outer diameter, which may be limited by the strengths of rotor materials subjected to centrifugal forces. The magnetization directions of the rotating magnets in this case may alternate along the body axis. The magnetization directions of the stationary magnets may also alternate along the body axis. For example, FIG. 4 shows three axial actuator targets 304a, 304b and 304c stacked sequentially along the rotational axis 303 of body 302. The axial actuator targets 304a, 304b and 304c may include first end-facing surfaces 305a, 305b and 305c respectively. The axial actuator targets 304a, 304b and 304c may also include second end-facing surfaces 306a, 306b and 306c respectively. The second end-facing surfaces 306a, 306b and 306c may have higher Z coordinates than the associated first end-facing surfaces 305a, 305b and 305c. The electromagnetic actuator 300 may include rotating magnets 307ab and 307bc affixed to the body 302. The rotating magnet 307ab may have its opposite poles magnetically coupled to the axial actuator targets 304a and 304b. The rotating magnet 307bc may have its opposite poles magnetically coupled to the axial actuator targets 304b and 304c. The rotating magnets 307ab and 307bc may have opposite magnetization directions.

The electromagnetic actuator 300 may include stationary axial control pole assemblies 308a, 308b and 308c stacked sequentially along the rotational axis 303 of body 302. The axial control pole assemblies 308a, 308b and 308c may include first axial control poles 309a, 309b and 309c. The axial control pole assemblies 308a, 308b and 308c may also include second axial control poles 310a, 310b and 310c. The first axial control poles 309a, 309b and 309c may be adjacent the first end-facing surfaces 305a, 305b and 305c of the axial actuator targets 304a, 304b and 304c, separated from them by radial air gaps and offset axially away from the axial actuator targets 304a, 304b and 304c respectively. The second axial control poles 310a, 310b and 310c may be adjacent the second end-facing surfaces 306a, 306b and 306c of the axial actuator targets 304a, 304b and 304c, separated from them by radial air gaps and offset axially away from the axial actuator targets 304a, 304b and 304c respectively. The first axial control poles 309a, 309b, 309c and the associated second axial control poles 310a, 310b and 310c may be magnetically coupled and, together with the axial actuator targets 304a, 304b, 304c encircle electrical coil 312a, 312b, 312c thereby defining magnetic circuits.

The electromagnetic actuator 300 may include stationary permanent magnet 315ab, which may have it opposite magnetic poles magnetically coupled to the axal control poles assemblies 308a and 308b. The electromagnetic actuator 300 may also include stationary permanent magnet 315bc, which may have it opposite magnetic poles magnetically coupled to the axal control poles assemblies 308b and 308c. The stationary permanent magnets 315ab and 315bc may have magnetization directions opposite to the magnetization directions of the associated rotating magnets 307ab and 307bc. The rotating magnet 307ab, the stationary magnet 315ab, the axial actuator targets 304a and 304b, the axial control pole assemblies 308a and 308b may define a first bias magnetic circuit with magnets 307ab and 315ab inducing a first bias magnetic flux. The rotating magnet 307bc, the stationary magnet 315bc, the axial actuator targets 304b and 304c, the axial control pole assemblies 308b and 308c may define a second bias magnetic circuit with magnets 307bc and 315bc inducing a second bias magnetic flux. The second bias magnetic flux may be directed opposite to the first bias magnetic flux.

The axial control coils 312a, 312b and 312c may be energized with electrical currents which directions may alternate sequentially from coil to coil along the Z axis 303. Depending on the magnetization direction of the permanent magnets 307ab, 307bc, 315ab and 315bc as well as the directions of the axial control currents in coils 312a, 312b and 312c, the axial control magnetic fluxes may add to or subtract from the bias fluxes on the second end-facing surface 306a, 306b and 306c, whereas they would oppositely subtract from or add to the bias fluxes on the first end-facing surface 305a, 305b and 305c, resulting in a net axial force F_{z} 301 exerted on the axial actuator targets 304a, 304b and 304c and subsequently transmitted to the body 302.

As above, the axial control pole assemblies 308a, 308b, 308c are shown residing entirely radially outward from the axial actuator targets 304a, 304b, 304c, permanent magnets 307ab and 307bc, and the body 302, In certain instances, this configuration enables the assembly convenience and/or design freedom discussed above.

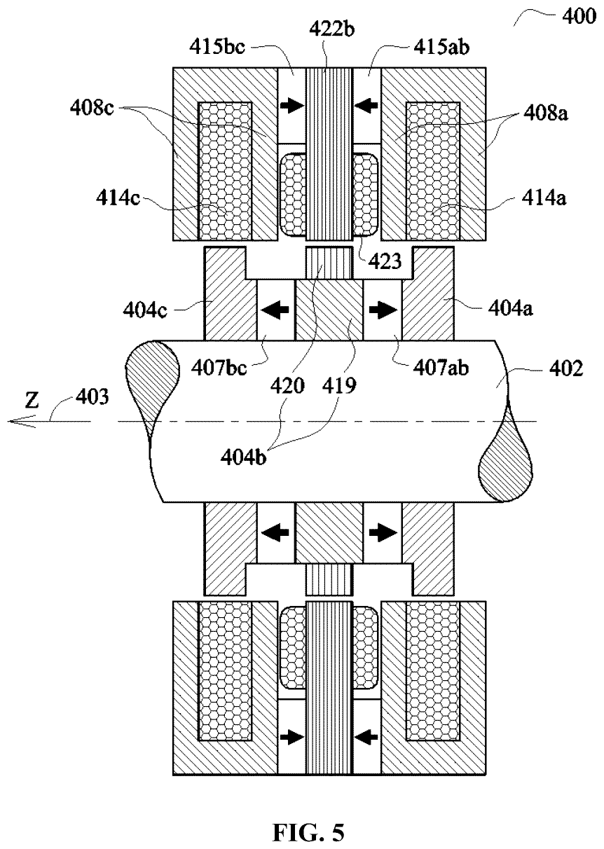

FIG. 5 shows an example of combining two axial control pole assemblies 408a and 408c with one radial control pole assembly 422b. The axial control pole assemblies 408a and 408c are working together with axial actuator targets 404a and 404c respectively. The radial control pole assembly 422b is working with the radial actuator target 404b including of solid portion 419 and laminated portion 420. The radial control pole assembly 422b in this embodiment is placed between two axial control pole assemblies 408a and 408c. The bias magnetic fields are induced by two rotating magnets 407ab and 407bc in combination with two stationary magnets 415ab and 415bc. The rotating magnet 407ab is placed between the axial actuator target 404a and radial actuator target 404b with its opposite poles magnetically coupled to the actuator targets 404a and 404b. The rotating magnet 407bc is placed between the radial actuator target 404b and the axial actuator target 404c with its opposite poles magnetically coupled to the actuator targets 404b and 404c. The rotating magnets 407ab and 407bc have opposite magnetization directions.

The stationary magnet 415ab is placed between the axial control pole assembly 408a and the radial control pole assembly 422b with its opposite poles magnetically coupled to the control pole assemblies 408a and 422b. The stationary magnet 415bc is placed between the radial control pole assembly 422b and the axial control pole assembly 404c with its opposite poles magnetically coupled to the control pole assemblies 422b and 408c. The stationary magnets 415ab and 415bc may have magnetization directions opposite to the magnetization directions of rotating magnets 407ab and 407bc respectively.

The axial control coils 414a and 414c, when energized with electrical currents, may induce axial control magnetic fluxes in the magnetic circuits formed by axial control pole assemblies 408a and 408c with axial actuator targets 404a and 404c respectively. When the axial control magnetic fluxes are superimposed on the bias magnetic fluxes, axial magnetic forces may be exerted on the axial actuator targets 404a and 404c, which may be subsequently transmitted to the body 402.

If the electrical control currents in the axial control coils 414a and 414c are equal and directed identically, the magnetic fluxes they induce in the radial control poles assembly 422b will cancel out and a compensation coil such as coil 228 in FIG. 2 may not be needed.

A set of radial control coils 423, when energized with electrical currents, may induce radial control magnetic fluxes in the magnetic circuits formed by radial control pole assembly 422b with the radial actuator target 404b. When the radial control magnetic fluxes are superimposed on the bias magnetic fluxes, radial magnetic forces may be exerted on the radial actuator target 404b, which may be subsequently transmitted to the body 402.

As above, the axial control pole assemblies 408a and 408b and radial control pole assembly 422b are shown residing entirely radially outward from the axial actuator targets 404a and 404c, permanent magnets 407ab and 407bc, radial actuator target 404b and the body 402, In certain instances, this configuration enables the assembly convenience and/or design freedom discussed above.

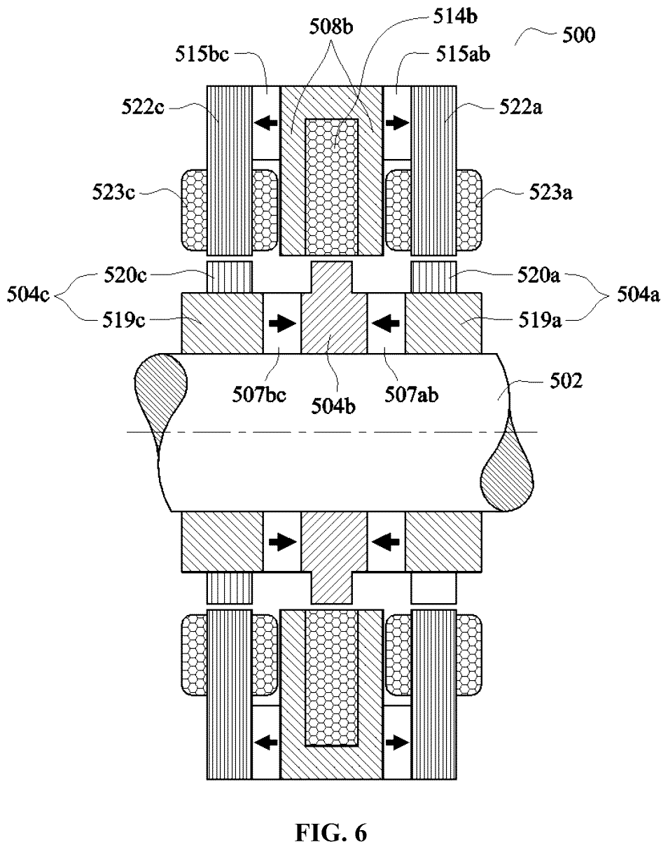

FIG. 6 shows an example of combining one axial control pole assembly 508b with two radial control pole assemblies 522a and 522c. The axial control pole assembly 508b is working together with axial actuator target 504b. The radial control pole assemblies 522a and 522c are working with the radial actuator targets 504a and 504c. The radial actuator target 504a includes of a solid portion 519a and a laminated portion 520a. The radial actuator target 504c includes of a solid portion 519c and a laminated portion 520c. The axial control pole assembly 508b in this embodiment is placed between two radial control pole assemblies 522a and 522c. The bias magnetic fields are induced by two rotating magnets 507ab and 507bc in combination with two stationary magnets 515ab and 515bc. The rotating magnet 507ab is placed between the radial actuator target 504a and the axial actuator target 504b with its opposite poles magnetically coupled to the actuator targets 504a and 504b. The rotating magnet 507bc is placed between the axial actuator target 504b and the radial actuator target 504c with its opposite poles magnetically coupled to the actuator targets 504b and 504c. The rotating magnets 507ab and 507bc have opposite magnetization directions.

The stationary magnet 515ab is placed between the radial control pole assembly 522a and the axial control pole assembly 508b with its opposite poles magnetically coupled to the control pole assemblies 522a and 508b. The stationary magnet 515bc is placed between the axial control pole assembly 508b and the radial control pole assembly 522c with its opposite poles magnetically coupled to the control pole assemblies 508b and 522c. The stationary magnets 515ab and 515bc have magnetization directions opposite to magnetization directions of rotating magnets 507ab and 507bc respectively.

The axial control coil 514b, when energized with an electrical current, may induce an axial control magnetic flux in a magnetic circuit formed by axial control pole assembly 508b with axial actuator target 504b. When the axial control magnetic flux is superimposed on the bias magnetic flux, an axial magnetic force may be exerted on the axial actuator target 504b, which may be subsequently transmitted to the body 502.

An electrical control current in the axial control coil 514b may induce parasitic magnetic fluxes in the radial control poles assemblies 522a and 522c, however such a parasitic flux may add to the bias flux in one of the radial control pole assemblies 522a and 522b, while subtracting from the bias flux in the other radial control pole assembly. As a result, the net effect of the parasitic magnetic fluxes may cancel out and a compensation coil, such as coil 228 in FIG. 2, may not be needed.

The sets of radial control coils 523a and 523c, when energized with electrical currents, may induce radial control magnetic fluxes in the magnetic circuits formed by radial control pole assemblies 522a and 522c with radial actuator targets 504a and 504c respectively. When the radial control magnetic fluxes are superimposed on the bias magnetic fluxes, radial magnetic forces may be exerted on the radial actuator targets 504a and 504c, which may be subsequently transmitted to the body 502.

As above, the axial control pole assembly 508b and radial control pole assemblies 522a and 522b are shown residing entirely radially outward from the axial actuator targets 504b, permanent magnets 507ab and 507bc, radial actuator targets 504a and 504b and the body 502, In certain instances, this configuration enables the assembly convenience and/or design freedom discussed above.

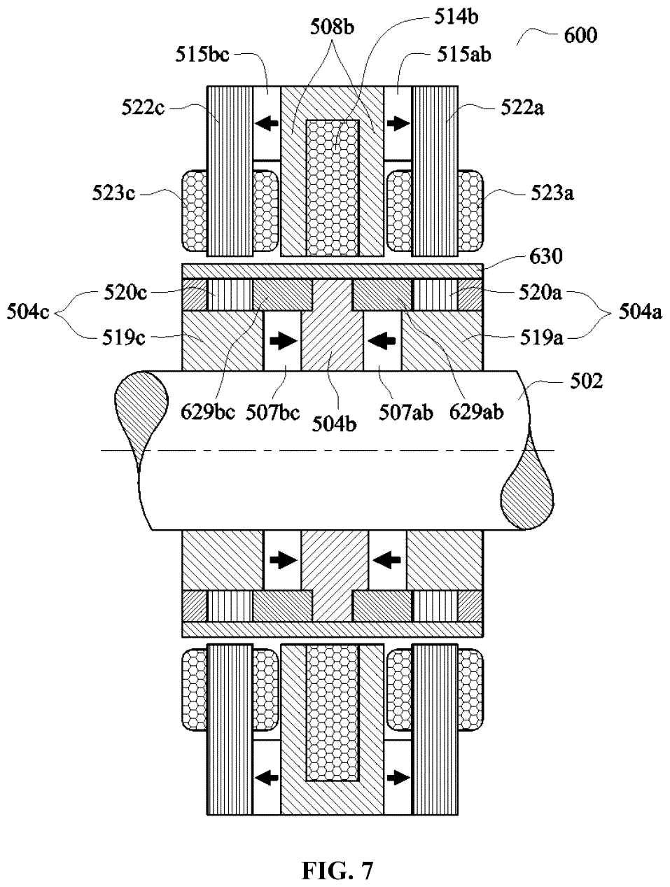

FIG. 7 uses the actuator embodiment shown in FIG. 6 to illustrate some practical design details which can be also applied to all the actuator embodiments per FIG. 1 through 6. Thus FIG. 7 shows rotating permanent magnets 507ab and 507bc covered with non-magnetic sleeves 629ab and 629bc. The sleeves may be shrunk on top of permanent magnets 507ab and 507bc and adjacent shoulders of equal diameters on the adjacent axial actuator target 504b and solid portions 519a and 519c of the radial actuator targets 504a and 504c. An interference fit can be introduced between the outer diameters of the magnets 507ab and 507bc and the inner diameters of the sleeves 629ab and 629bc to keep the magnet material in compression through the entire operating speed range of the machine. This may be needed because permanent magnet materials typically exhibit much smaller strength in tension than in compression and without retaining sleeves 629ab and 629bc may be destroyed by centrifugal forces.

FIG. 7 also shows a non-magnetic sleeve 630 shrunk over the entire circumferential surface of the rotor assembly including the radial actuator targets 504a and 504c and the axial actuator target 504b. This sleeve may be beneficial when the rotor operates in an aggressive environment, such as one including sour gas (H2S). Sour gas is detrimental for magnetic materials needed for the actuator targets 504a, 504b and 504c, such as carbon steels and silicon steel, but do not affect many non-magnetic materials such as austenitic stainless steels, which can be used for the sleeve 630.

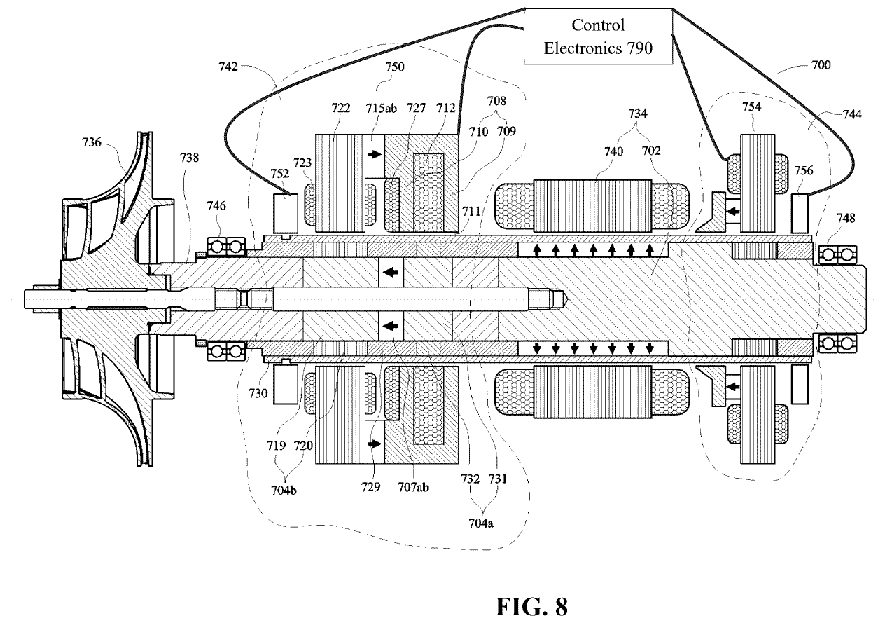

In some aspects, the proposed axial or combination axial/radial homopolar permanent magnet biased electromagnetic actuator per FIG. 1 thru 7 may be utilized as a part of an Active Magnetic Bearing (AMB) system to support a rotor of a rotational machine without a mechanical contact. In particular, when an AMB system is used in rotating machinery, the proposed actuator may facilitate the machine assembly as the rotor can be simply slid into the stator and may enable sleeving rotor portions associated with electromagnetic actuators to protect them from aggressive environments. FIG. 8 shows an example of using an AMB system in an electric rotational machine 700. The rotational electric machine 700 can be, for example, an electric motor 734 driving an impeller 736 (e.g., liquid and/or gas impeller) mounted directly on the motor shaft 738. The electric motor 734 shown in FIG. 8 has a rotor 702 and a stator 740. Alternatively, the impeller 736 can be configured as a turbine to be driven by a flow of gas or liquid and spin the rotor 702 attached to it through the shaft 702. In certain instances, the rotor 702 can additionally or alternatively be coupled to another type of driver such as another electric motor or an engine to spin the rotor. In this case the motor 734 can be used as a generator which would convert the mechanical energy of the rotor 702 into electricity. In embodiments, the rotor 702 of the electric machine 700 can be supported radially and axially without mechanical contact by means of front and rear radial AMBs 742 and 744. The front AMB 742 provides an axial suspension of the rotor 702 and a radial suspension of the front end of the rotor, whereas the rear AMB 744 provides only radial suspension of the rear end of the rotor 702. When the AMBs 742 and 744 are not working, the rotor rests on the mechanical backup bearings 746 and 748. The front backup bearing 746 may provide the axial support of the rotor 702 and a radial support of the rotor front end, whereas the rear backup bearing 746 may provide radial support of the rear end of the rotor 702. There are radial clearances between the inner diameters of the mechanical backup bearings 746, 748 and the outer diameters of the rotor portions interfacing with those bearing to allow the rotor 702 to be positioned radially without touching the backup bearings 746, 748 when the AMBs 742 and 744 are activated. Similarly, there are axial clearances between the backup bearings 746, 748 and the portions of the rotor 702 interfacing with those bearings to allow the rotor 702 to be positioned axially without touching the backup bearings 746 and 748 when the AMBs 742 and 744 are activated.

The front AMB 742 includes of a combination axial and radial electromagnetic actuator 750 per the concepts described herein, radial and axial position sensor assembly 752 and control electronics 790. The electromagnetic actuator 750 in accordance with the concepts described herein may be capable of exerting axial forces on the axial actuator target 704a and radial forces on the radial actuator target 704b, both rigidly mounted on the rotor 702. The radial actuator target 704b may include of a solid portion 719 and a laminated portion 720. The axial actuator 704a may be also composed of two portions 731 and 732, both made of a soft-magnetic material, to facilitate the rotor assembly. The electromagnetic actuator 700 may include a rotating magnet 707ab affixed to the rotor 702 and having its opposite poles magnetically coupled to the axial actuator target 704a and the radial actuator target 704b.

The electromagnetic actuator 750 may include a stationary axial control pole assembly 708 comprising two axial control poles 709 and 710 adjacent the opposite end-facing surfaces of the axial actuator target 704a, separated from the axial actuator target 704a by radial air gap 711 and offset axially away from it. The first axial control pole 709 and the second axial control pole 710 may be magnetically coupled and, together with the axial actuator target 704a, define an axial control magnetic circuit. An electrical coil 712 may be adapted to induce an axial control magnetic flux in the axial control magnetic circuit when energized with an electrical current.

The electromagnetic actuator 750 may include radial control pole assembly 722 which may be adjacent the exterior lateral surface of the radial actuator target 704b and separated from it by radial air gap 711. The stationary radial control pole assembly 722 may include of at least three radial control poles distributed around the body in a single plane perpendicular to the body axis. The radial control poles are adjacent and spaced apart from an exterior lateral surface of the associated radial actuator target 704b magnetically coupled to each other and to the laminated portion 720 of the radial actuator target 704b to form a plurality of radial control magnetic circuits. The radial control pole may be equipped with radial control windings 723, which may induce radial control magnetic fluxes in the radial control magnetic circuits when energized with radial control electric currents.

The electromagnetic actuator 750 may include a stationary permanent magnet 715ab, which may be placed between the axial control pole 710, closest to the radial control pole assembly 722, and the radial control pole assembly 722. The axial control pole 710 and the radial control pole assembly 721 may be magnetically coupled to the opposite poles of the stationary permanent magnet 715ab. The stationary permanent magnet 715ab may have the magnetization direction opposite the magnetization direction of the rotating permanent magnet 707ab. The permanent magnet 715ab and 707ab, the axial actuator target 704a, the radial actuator target 704b, the axial control pole assembly 708 and the radial control pole assembly 722 define a bias magnetic circuit with magnets 715ab and 707ab inducing a bias magnetic flux.

Depending on the magnetization directions of the permanent magnets 707ab and 715ab as well as the direction of the axial control current, the axial control magnetic flux may add to or subtract from the bias flux on one of the end-facing surfaces of the axial target 704a, while doing the opposite on the other end-facing surface of the axial target 704a. This may result in a higher magnetic flux density on one end-facing surface of the axial target 704a than on the other, causing a net axial force exerted on the axial actuator target 704a and subsequently transmitted to the rotor 702. Depending on the magnetization direction of the permanent magnets 707ab and 715ab as well as the directions of the radial control currents such in the coils 723, the radial control magnetic fluxes these currents produce may add to or subtract from the bias fluxes in the radial control poles 722, which may cause radial forces exerted on the radial actuator target 704b and subsequently transmitted to the rotor 702. To prevent the axial control current affecting the bias magnetic flux, a compensation coil 727 with a compensation current opposite to the axial control current may be added between the second axial control pole 210 and the radial control pole assembly 222 as described in the U.S. Pat. No. 8,482,174.

A non-magnetic sleeve 729ab may be shrunk on top of permanent magnet 707ab and adjacent shoulders of equal diameters on the adjacent inner portion 731 of the axial actuator target 704a and solid portion 719b of the radial actuator target 704b. An interference fit can be introduced between the outer diameter of the magnets 707ab and the inner diameters of the sleeve 729ab to keep the magnet material in compression through the entire operating speed range of the machine. This may be needed because permanent magnet materials typically exhibit much smaller strength in tension than in compression and without the retaining sleeve 729ab may be destroyed by centrifugal forces.

FIG. 8 also shows a non-magnetic sleeve 730 shrunk over the entire circumferential surface of the rotor assembly including the axial actuator target 704a and the radial actuator target 704b. This sleeve may be beneficial when the rotor operates in an aggressive environment, such as one including sour gas (H2S). Sour gas is detrimental for magnetic materials needed for the actuator targets 704a, 704b, such as carbon steels and silicon steel, but do not affect many non-magnetic materials such as austenitic stainless steels, which can be used for the sleeve 730.

The position of the front end of the rotor in space is monitored by radial and axial position sensor assembly 752. Signals from the position sensors 752 may be input into the control electronics 790, which may generate currents in the control coils of the electromagnetic actuator 750 when it finds that the rotor is deflected from the desired position such that these currents may produce forces pushing the rotor back to the desired position.

The rear AMB 744 includes of a radial electromagnetic actuator 754, radial non-contact position sensors 756, and control electronics 790. It may function similarly to the front AMB 742 except that it might not be configured to control the axial position of the rotor 702 because this function is already performed by the front AMB 744. Correspondingly, the electromagnetic actuator 742 may not be able to produce controllable axial force and there may be no axial position sensor.

The present disclosure describes embodiments of an electromagnetic actuator capable of exerting axial and radial forces on rotary objects through radial air gaps without mechanical contact. Other embodiments and advantages are recognizable by those of skill in the art by the forgoing description and the claims.

What is claimed is:

1. An electromagnetic actuator configured to support a body to rotate about a rotational axis, the electromagnetic actuator comprising:
an axial actuator target affixed to the body, the axial actuator target having a first end-facing surface and a second end-facing surface;
a stationary axial control pole assembly comprising a first axial control pole and a second axial control pole, the first axial control pole and the second axial control pole entirely radially outward from the body and the axial actuator target and separated from the axial actuator target by radial air gaps;
the first axial control pole residing adjacent the first end-facing surface of the axial actuator target, offset axially away from the axial actuator target and adapted to communicate magnetic flux with the first end-facing surface of the axial actuator target;
the second axial control pole residing adjacent the second end-facing surface of the axial actuator target, offset axially away from the axial actuator target and adapted to communicate magnetic flux with the second end-facing surface of the axial actuator target;
the first axial control pole and the second axial control pole magnetically coupled and cooperating with the axial actuator target to define an axial magnetic control circuit;
an axial control coil configured to induce an axial control magnetic flux in the axial magnetic control circuit when energized with electrical axial control current; and
a permanent magnet affixed to the body to rotate with the body, the permanent magnet having one of its magnetic poles magnetically coupled to the axial actuator target and configured to induce a bias magnetic flux flowing between the axial actuator target and the axial control pole assembly.

2. The electromagnetic actuator of claim 1 wherein the axial actuator target is a first actuator target and the electromagnetic actuator further comprises a second actuator target affixed to the body and magnetically coupled to the second magnetic pole of the rotating permanent magnet; and
wherein the stationary axial control pole assembly is a first stationary control pole assembly and the electromagnetic actuator further comprises a second stationary control pole assembly; and
wherein the electromagnetic actuator further comprises a permanent magnet between the first stationary control pole assembly and the second stationary control pole assembly and having its first magnetic pole magnetically coupled to the first stationary control pole assembly and its second magnetic pole magnetically coupled to the second stationary control pole assembly, the permanent magnet having a magnetization direction opposite to the magnetization direction of the permanent magnet affixed to the body; the first stationary control pole assembly, the permanent magnet between the control pole assemblies, the second stationary control pole assembly and the permanent magnet affixed to the body define a bias magnetic circuit where the permanent magnets induce a bias magnetic flux in the bias magnetic circuit.

3. The electromagnetic actuator of claim 2 wherein the second actuator target is a second axial actuator target, the second stationary pole assembly is a second stationary axial control pole assembly, the axial magnetic control circuit is the first axial magnetic control circuit, the axial control magnetic flux is the first axial control magnetic flux,
the second axial actuator target comprises a first end-facing surface and a second end-facing surface;
the second stationary axial control pole assembly comprises a first axial control pole and a second axial control pole, the first axial control pole and the second axial control pole of the second stationary axial control pole assembly are entirely radially outward from the second axial actuator target and body and separated from the second axial actuator target by radial air gaps;
the first axial control pole of the second stationary axial control pole assembly residing adjacent the first end-facing surface of the second axial actuator target, offset axially away from the second axial actuator target and adapted to communicate magnetic flux with the first end-facing surface of the second axial actuator target;
the second axial control pole of the second stationary axial control pole assembly residing adjacent the second end-facing surface of the second axial actuator target, offset axially away from the second axial actuator target and adapted to communicate magnetic flux with the second end-facing surface of the second axial actuator target;
the first axial control pole and the second axial control pole of the second stationary axial control pole assembly magnetically coupled and cooperating with the second axial actuator target to define a second axial magnetic control circuit; and
a second axial control coil configured to induce a second axial control magnetic flux in the second axial magnetic control circuit when energized with a second electrical axial control current that is directed oppositely to the first electrical axial control current.

4. The electromagnetic actuator of claim 2 wherein the second actuator target is a radial actuator target having an exterior lateral surface; and
wherein the electromagnetic actuator further comprises a stationary radial control pole assembly, the stationary radial control pole assembly comprising three radial control poles in a plane perpendicular the body rotational axis around the associated radial actuator target, the radial control poles being magnetically couped to each other and the radial actuator target forming a plurality of radial control magnetic circuits; and
a plurality of radial control coils each wound around a respective one of radial control poles, and when energized with electrical radial control currents, the radial control coils produce respective radial control magnetic fields.

5. The electromagnetic actuator of claim 4 wherein a bias compensation coil wound around the body rotational axis is between the axial control pole assembly and the radial control pole assembly; the bias compensation coil is energized with a bias compensation electrical current opposite and proportional to the axial control current to maintain the bias flux constant or nearly constant when the axial control current changes.

6. The electromagnetic actuator of claim 1 comprising a non-magnetic magnet sleeve enclosing the permanent magnet affixed to the body, the sleeve configured to maintain the magnet material in compression.

7. The electromagnetic actuator of claim 1 comprising a protective non-magnetic sleeve enclosing the axial actuator target.

8. The electromagnetic actuator of claim 2 comprising protective non-magnetic sleeves respectively enclosing the first actuator target and the second actuator target.

9. A method for exerting an electromagnetic force on a body along a body axis, the method comprising:
with a magnetically permeable axial actuator target having a first end-facing surface and a second end-facing surface to the body;
a first stationary axial control pole adjacent to the first end-facing surface of the axial actuator target, the first stationary axial control pole being entirely radially outward from the axial actuator target and body and separated from the axial actuator target and the body by a radial air gap and offset axially away from the axial actuator target;
a second stationary axial control pole adjacent to the second end-facing surface of the axial actuator target, the second stationary axial control pole being entirely radially outward from the axial actuator target and the body, separated from the axial actuator target and the body by a radial air gap and offset axially away from the axial actuator target;
the first stationary axial control pole and the second stationary axial control pole magnetically connected so that the first stationary axial control pole, the second stationary axial control pole and the axial actuator target form an axial control magnetic circuit; and
a permanent magnet affixed to the rotor and producing a bias magnetic field in the axial actuator target so that the bias magnetic field propagates between the axial actuator target and the first stationary axial control pole and between the axial actuator target and the second stationary axial control pole;
generating axial control magnetic flux in an electrical axial control coil in the axial control magnetic circuit with an axial control electrical current, the axial control magnetic flux adding to the bias magnetic flux on one of the end-facing surfaces of the axial actuator target while subtracting from the bias magnetic flux on the other end-facing surface of the axial actuator target so that the difference in magnetic fluxes on two end-facing surfaces of the axial actuator target result in an axial electromagnetic force exerted on the axial actuator target.

10. An electric machine system comprising:
a stator;
a rotor having a rotational axis configured to rotate the rotational axis relative to the stator;
an electromagnetic actuator subassembly comprising:
an axial actuator target rigidly affixed to the rotor and having first and second end-facing surfaces;
a radial actuator target affixed to the rotor and having an exterior lateral surface,
a stationary axial control pole assembly comprising a first axial control pole and a second axial control pole;
the first stationary axial control pole residing adjacent the first end-facing surface of the axial actuator target, entirely radially outward from the axial actuator target and body, separated by a radial air gap and offset axially away from the axial actuator target, the first stationary axial control pole adapted to communicate magnetic flux with the first end-facing surface of the second axial actuator target;
the second stationary axial control pole residing adjacent the second end-facing surface of the axial actuator target, entirely radially outward from the axial actuator target and body, separated by a radial air gap and offset axially away from the axial actuator target, the second stationary axial control pole adapted to communicate magnetic flux with the second end-facing surface of the axial actuator target, the second stationary axial control pole being magnetically coupled to the first stationary axial control pole, and the first stationary axial control pole, the second stationary axial control pole and the axial actuator target forming an axial control magnetic circuit;
an axial control electrical coil adapted to produce an axial control magnetic flux in the axial control magnetic circuit;
the radial control pole assembly comprising three radial control poles in a plane perpendicular the body rotational axis around the radial actuator target, the radial control poles being entirely radially outward from the radial actuator target and body separated from the radial actuator target by radial gaps, magnetically couped to each other and to the radial actuator target to form a plurality of radial control magnetic circuits;
a plurality of radial control coils each wound around a respective one of the radial control poles, and when energized with electrical radial control currents, the radial control coils produce respective radial control magnetic fields;
a first permanent magnet affixed to the rotor and configured to produce a bias magnetic flux in the axial actuator target, the bias magnetic flux traveling from the axial actuator target into the axial control poles, and where the axial control magnetic flux superimposed on the bias flux causes an axial electromagnetic force;
a second permanent magnet affixed to the rotor and configured to produce a bias magnetic flux in the radial actuator target, the bias magnetic flux traveling from the radial actuator target into the radial control poles, and where he radial control magnetic fluxes superimposed on the bias flux causes radial electromagnetic forces;
a position sensor configured to sense a position of the rotor; and
a control electronics package configured to control the magnetic fluxes in the axial magnetic control circuit and the radial magnetic control circuits.

11. The electric machine system of claim 10 wherein the rotor is coupled to an impeller.

12. The electric machine system of claim 10 wherein the rotor is coupled to a driver, the driver comprising at least one of a motor, an engine, or a turbine.

13. The electric machine system of claim 10 wherein the electronic control package is configured to control the magnetic fluxes in the axial and radial magnetic control circuits by energizing the axial and radial control coils with control currents.

14. The electric machine system of claim 13 wherein the electronic control package is further configured to control the magnetic fluxes based signals from the position sensor to support the rotor without a mechanical contact with the stator.
